(19) United States
(12) Patent Application Publication
(10) Pub. No.: US 2025/0344042 A1
(43) Pub. Date: Nov. 6, 2025

(54) Zero Latency Location for Mobile Devices on Telecommunications Network

(71) Applicant: Radar Labs, Inc., New York, NY (US)

(72) Inventor: Nicholas Patrick, Jersey City, NJ (US)

(21) Appl. No.: 19/193,156

(22) Filed: Apr. 29, 2025

Related U.S. Application Data
(60) Provisional application No. 63/642,077, filed on May 3, 2024.

(51) Int. Cl. H04W 4/029; H04W 4/02

(52) U.S. Cl. CPC H04W 4/029; H04W 4/025

(57) ABSTRACT

Systems and methods for low-latency geolocation checks include retrieving updated geolocation tokens at regular intervals and caching the geolocation tokens in local memory on a mobile device. The geolocation tokens are retrieved from the cache in response to location check requests from other processes running on the mobile device.

### CROSS-REFERENCE TO RELATED APPLICATIONS

This application claims the benefit of Provisional Patent Application No. 63/642,077 filed May 3, 2024, and titled “Zero Latency Location for Mobile Devices,” which is incorporated by reference herein in its entirety.

### TECHNICAL FIELD

The present disclosure generally relates to telecommunication devices, and in particular to systems and methods for determining locations for telecommunication devices.

### BACKGROUND

Geofencing is a technology that creates virtual boundaries around a physical location, enabling software applications to trigger specific actions or alerts when a device enters or exits these predefined areas. Geofencing systems rely on a combination of GPS, RFID, Wi-Fi, and cellular data to accurately determine the device's location relative to the geofenced region. When a device equipped with the necessary geofencing software approaches the boundary, it communicates with the central server, which then executes the programmed response. This response can range from sending notifications to the user, tracking the device's movements, or initiating automated actions such as locking doors or adjusting settings of a system. Geofencing is widely used in various applications, including security systems, fleet management, location-based marketing, and personal safety apps, offering businesses and individuals enhanced control and monitoring of their spatial environments.

In some use cases, an application running on a mobile device, such as a cell phone, may require a real-time location for the mobile device. While the current GPS coordinates (e.g., latitude and longitude) can be retrieved from a GPS receiver on the device, the application may require other kinds of location information, such as the current city, state, country, or other location information. Moreover, in some use cases, adversarial agents may attempt to spoof a devices location, so that simply retrieving GPS coordinates from the device may not be sufficient to provide trusted location information.

There is a need in the art for a system and method that addresses the shortcomings discussed above.

### SUMMARY

In some aspects, the techniques described herein relate to a mobile device, including: a processor; a non-transitory computer-readable media storing instructions that are executable by the processor to: request a geolocation token from a server; receive the geolocation token from the server; receive expiration information for the geolocation token; store the geolocation token in memory at the mobile device; store the expiration information in memory at the mobile device; receive, from a mobile application process running on the mobile device, a token request; retrieve the geolocation token and the expiration information from memory; determine that the geolocation token is still valid according to the expiration information; and provide the geolocation token to the mobile application process.

In some aspects, the techniques described herein relate to a computer-implemented method running on a mobile device, including: requesting a geolocation token from a server; receiving the geolocation token from the server; receiving expiration information for the geolocation token; storing the geolocation token in memory at the mobile device; storing the expiration information in memory at the mobile device; receiving, from a mobile application process running on the mobile device, a token request; retrieving the geolocation token and the expiration information from memory; determining that the geolocation token is still valid according to the expiration information; and providing the geolocation token to the mobile application process.

In some aspects, the techniques described herein relate to a computer-implemented method, including: receiving a first request for a first geolocation token from an application running on a mobile device; generating the first geolocation token; sending the first geolocation token to the application running on the mobile device, the first geolocation token expiring at a first expiration time; receiving, before the first expiration time, a second request for a second geolocation token from the application running on the mobile device; and generating the second geolocation token; sending the second geolocation token to the application running on the mobile device, the second geolocation token expiring at a second expiration time that is later than the first expiration time.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic view of an architecture for providing geolocation tokens to one or more processes running on a mobile device, according to an embodiment.

FIG. 2 is a schematic view of various modules and processes running on systems that provide geolocation tokens, according to an embodiment.

FIG. 3 is a schematic view of an exemplary web token, according to an embodiment.

FIG. 4 is a schematic view of a sample payload for a web token, according to an embodiment.

FIG. 5 is a schematic view of a process of updating geolocation tokens, according to an embodiment.

FIGS. 6 and 7 depict schematic views of a scenario where systems may provide near zero latency for location information upon a request from an application, according to an embodiment.

FIG. 8 is a schematic view of a process for retrieving a geolocation token in response to a request from a mobile application, according to an embodiment.

FIG. 9 is an exemplary process for refreshing geolocation tokens in response to triggers, according to an embodiment.

FIG. 10 is a schematic view of an exemplary telecommunications network, according to an embodiment.

### DETAILED DESCRIPTION

Location (or geolocation) platforms enable location information that is sufficiently robust and trusted to be delivered to applications that require the location information. For example, some gaming applications, including applications that enable online gambling, utilize third-party location platforms to perform location checks at regular intervals. The location platforms act to transform raw location data (such as a latitude and longitude), as well as raw device and user information, into a robust packet of location and user/device information that can be easily used by the application to confirm, for example, that a given user device registered to a gaming user is currently located in a particular city and state. For example, gaming applications that allow users to wager money may be required to make frequent checks of a user's location according to federal, state and/or local laws. As an example, a state may require that any gaming system has a geolocation system that detects the physical location of a player: (1) when a player first logs into the gaming system or makes an initial bet or wager using the interactive gaming system; and (2) if a gaming session is longer than a single bet or wager and the player is using a static connection or mobile internet connection, a geolocation re-check shall be performed every 20 minutes, or 5 minutes if the plater is located within 1 mile of the border of commonwealth.

A drawback of some architectures is that the act of requesting this location information may be time consuming, on the order of several seconds or longer, as the local client of the gaming application running on the mobile device makes a request for the transformed location information from the server side of the platform.

The embodiments provide systems and methods that provide low-latency, or even zero-latency, geolocation information for software applications, including mobile applications running on a mobile device. The geolocation information may be provided as a “geolocation token” (or “location token”) which includes location information as well as, optionally, other information including an expiration time/date of the token and other information (such as user information and/or device information).

Rather than requesting a “fresh” geolocation token every time one is needed, the embodiments provide systems and methods that may return a “cached” geolocation token as long as it's still valid. The validity may be determined, at least in part, by an expiration date and time, which itself may be determined as a function of the user's location (such as a state) and the user's proximity to any associated border (such as a state border). If the system is able to retrieve a valid cached token, this results in a location check with zero latency (or near zero latency). Moreover, the architecture of the system provides a way to continuously refresh new tokens at a rate that ensures the system will always have a non-expired token stored in cache at the time any location request is made by the application.

Additionally, the systems and methods include processes for updating cached geolocation tokens before any current tokens are set to expire. In some cases, this allows zero-latency for location checks every time an application makes a location request. To ensure there are always valid tokens, the system may automatically update tokens frequently enough so that new tokens are cached before existing tokens expire. In some cases, the system checks for triggers and immediately requests for new tokens before existing cached tokens are invalidated by changes in location, networks, or other factors.

The resulting architecture facilitates low latency for location checks, enabling seamless operation of a gaming application. By contrast, architectures that make server calls at the time that a location check is requested may have higher latency, which may reduce user experience and possibly lead to financial losses for a company operating the gaming application.

The description may employ various terms as described herein.

As used herein, “caching” refers to the process of storing data in a cache. A cache may be any suitable temporary storage area associated with any suitable type of memory or other data storage. Cached data may generally be retrieved faster relative to other types of data in a data storage architecture.

For purposes of this application, an Application Programming Interface (API) may generally be understood to include a library of program elements such as functions, routines, protocols, or processes associated with a particular operating system or computing platform. The program elements may be software-based functions and/or processes in the form of source code, scripts, and/or executable code. The computing platform may include software and/or hardware. For example, the hardware may include a type of processor or hardware system. The software may include a version of an operating system such as Apple® iOS, MacOS®, Microsoft Windows®, Android® OS, UNIX, LINUX, or like environments that allow for running or executing an application and/or program. An API allow application programmers or providers to develop an application program capable of interfacing with the specified computing platform by incorporation of programs from the API library into the application program. A programmer may use a software development kit (SDK) or other tool to develop application programs. A development tool may include APIs or may enable the developer to remotely access APIs for a particular computer platform. Currently, most APIs are either openly accessible or include access control capabilities as part of the API.

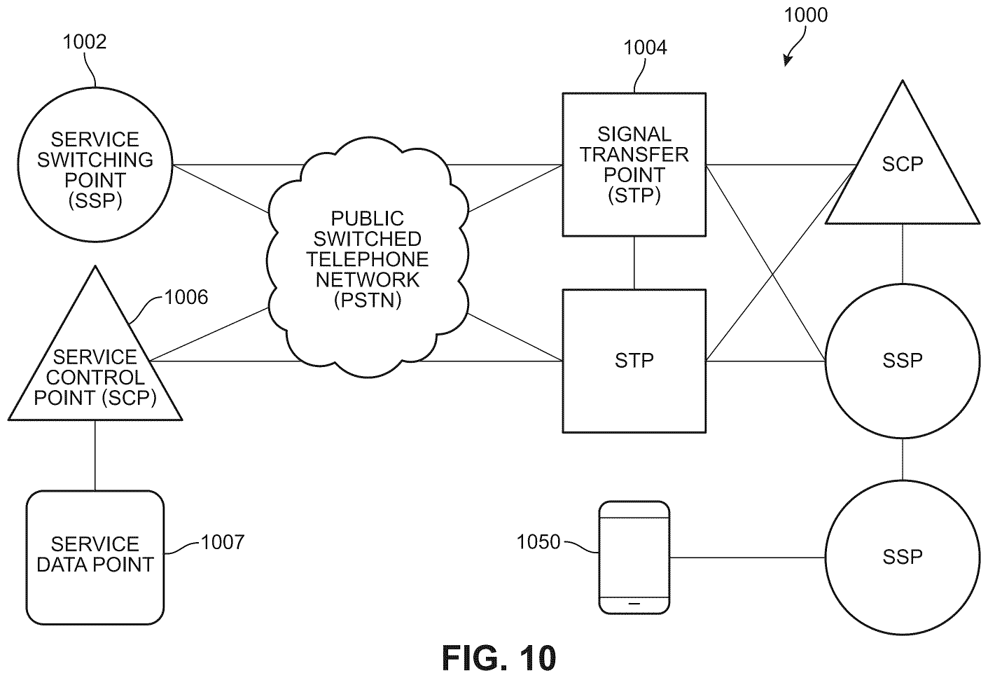

A “telecommunications device” may be any device configured to send and receive calls and interface with a “telecommunications network”. A telecommunications network may comprise a group of interconnected nodes. The nodes may be connected by telecommunications links that facilitate the exchange of messages between the nodes. The links may use a variety of technologies based on the methodologies of circuit switching, message switching, or packet switching, to pass messages and signals. Examples of telecommunications networks include computer networks, the Internet, the public switched telephone network (PSTN), the global Telex network, the aeronautical ACARS network, and the wireless radio networks of cell phone telecommunication providers. One exemplary telecommunications network that may interface with a telecommunications device of the embodiments is described in further detail below and shown in FIG. 10.

Moreover, a mobile telecommunications device may be a mobile device that is configured to send and/or receive calls. Examples of mobile telecommunication devices include cell phones, tablets, smart watches, and other suitable mobile devices configured to communicate over one or more telecommunications networks.

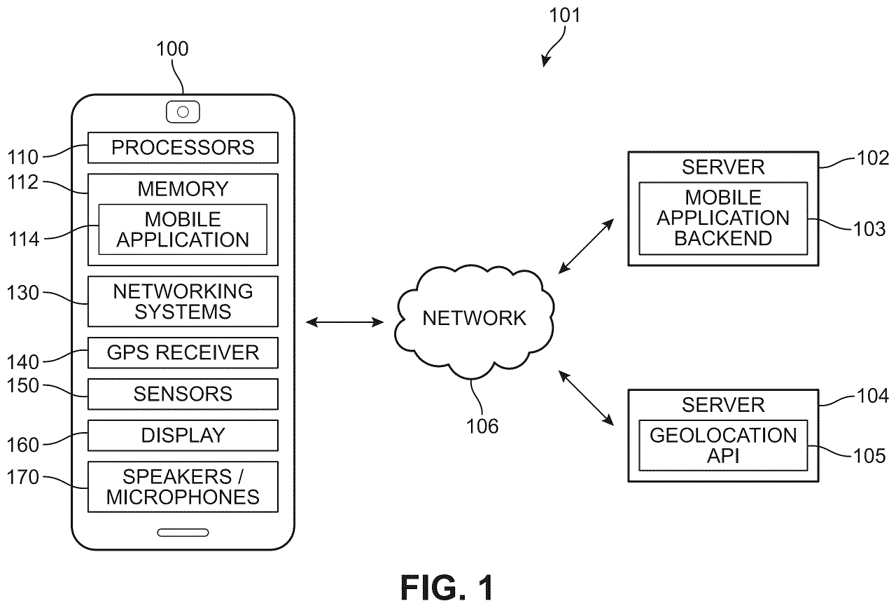

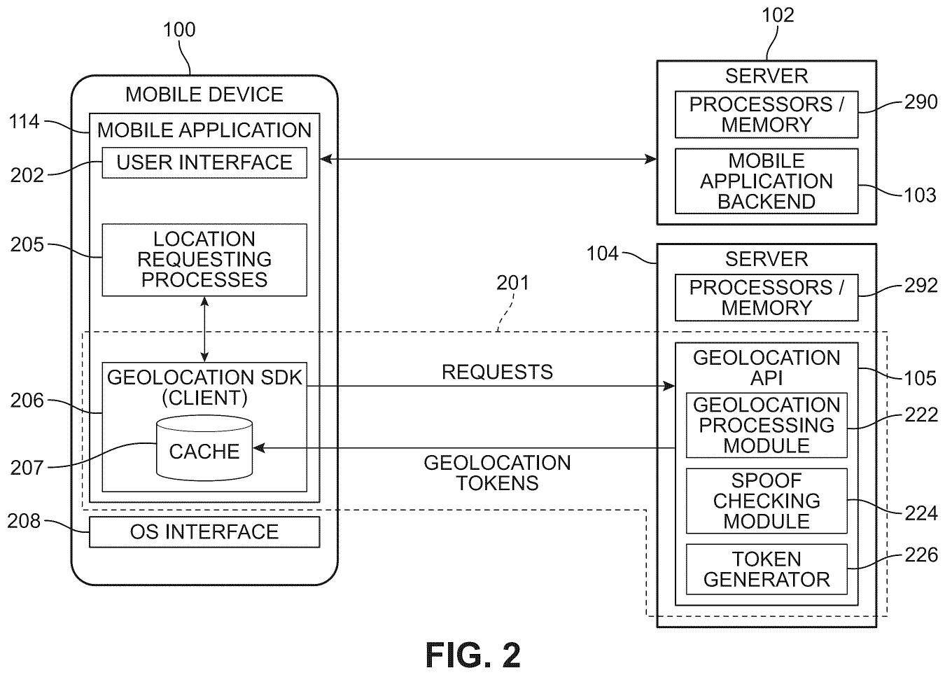

Some embodiments may utilize an architecture 101 as shown in FIGS. 1 and 2. Referring first to FIG. 1, a mobile telecommunications device 100 (also referred to as “mobile device 100” or simply “device 100”) may be in communication with a first server 102 and a second server 104 over a network 106.

Mobile device 100 may comprise any suitable computing system. Mobile device 100 may include processors 110 and memory 112. Memory 112 may comprise a non-transitory computer readable medium storing instructions that may be executed by processors 110.

Each of first server 102 and second server 104 may comprise any suitable computing systems. In some embodiments, servers may include suitable processors and memory to execute functions related to processing instructions stored in memory. For example, as shown in FIG. 2, first server 102 comprises processors and memory 290 while second server 104 comprises processors and memory 292.

In some embodiments, first server 102 may be configured to host a mobile application backend 103. Mobile application backend 103 may communicate with a corresponding front end mobile application, which resides and runs on mobile device 100, as described in further detail below.

In some embodiments, second server 104 may be configured to host the backend of a location platform. In some cases, the backend of the location platform comprises an API, which may be referred to as a geolocation API 105. In some cases, geolocation API 105 may communicate with a corresponding front end that includes a client of the location platform that also resides on mobile device 100, as discussed in further detail below.

Network 106 may comprise any suitable network including, but not limited to, WiFi networks, cellular networks, personal area networks, local area networks, wide area networks, and other suitable networks. Further details of suitable networks are discussed later in this detailed description.

Moreover, it may be appreciated that in other embodiments, mobile device 100 may communicate using different networks to communicate with each of first server 102 and second server 104. Still further, in some embodiments, first server 102 and second server 104 may communicate directly over network 106 or any other suitable network. For example, in situations where data packets are “signed”, it may be necessary to transfer secret keys between first server 102 and second server 104.

Mobile device 100 may include one or more networking systems 130. Networking systems 130 may include suitable hardware and/or software components for communicating with other computing systems over a network. Further details of suitable components for networking systems are discussed later in this detailed description.

Mobile device 100 may include provisions for retrieving information related to the device's location. In some embodiments, the mobile device may include a GPS receiver 140. A GPS receiver includes hardware and software that allows a device to determine its location (including longitude and latitude) based on signals from satellites. Alternative satellite systems may also be supported, such as GLONASS, Galileo, and BeiDou. In some embodiments, two or more of these networking modules may integrated into a single chipset or SoC (System on Chip). The SoC may include one or more antennas for transmitting and/or receiving signals.

Mobile device 100 may include one or more sensors 150. Exemplary sensors may include, but are not limited to: accelerometers, gyroscopes, magnetometers, proximity sensors, ambient light sensors, barometers, temperature sensors, hall sensors, time of flight sensors, optical sensors (cameras), LIDAR scanners, and other suitable sensors.

Mobile device 100 may include a display 160. Display 160 may provide a means for displaying output and may also allow for input via, for example, a touchscreen.

Mobile device 100 may also include speakers and/or microphones 170 to facilitate functionality including placing and receiving phone calls.

In some embodiments, mobile device 100 includes one or more mobile applications. As an example, in FIG. 1, mobile application 114 is shown stored in memory. Mobile application 114 comprises a set of instructions stored in memory 112 that may be executed by the one or more processors 110.

In the context of the embodiments, mobile application 114 may be a suitable application that requires that the location of the user's mobile device be checked one or more times while the application is being used. For example, some types of online gaming products require verification that the device running the application is located in a particular geographic region. For example, applications for online gambling may require verification that the mobile device is located in a particular state before a user can place a bet, as gambling laws may vary from one state to another.

Although the present embodiment describes an architecture for facilitating location checks on a mobile device, such as a cell phone or tablet, in other embodiments location checks may be enabled on any other suitable computing systems. In some cases, for example, location checks may be enabled on a desktop computer, server, or other suitable computing device. As an example, a user may access an online gambling site through a web application on a desktop browser. In such embodiments, the computing device (such as a desktop computer) may be configured with similar provisions to mobile device 100, including running an application for facilitating location checks on the client side, sensors, a GPS receiver, networking systems, and other similar provisions.

Referring now to FIG. 2, mobile application 114 may include one or more modules, subprocesses, or other components. For example, mobile application 114 may include a user interface 202. User interface 202 may comprise a collection of UI elements that allow a user to interact with the mobile application, for example, a gaming application.

Mobile application 114 may utilize geofencing to modify functionality based on a mobile device's location. As part of this process, the mobile application may need to determine the location of the mobile device to check if the device is located inside (or outside of) a predetermined boundary (such as a state boundary).

In some embodiments, a mobile application may utilize a sub-module or set of sub-processes to perform functionality related to geofencing, and to determining a device's location more generally.

In some embodiments, mobile application 114 may include a software module for determining location information. In some embodiments, the software module may be implemented as a software development kit (SDK). This so-called “geolocation SDK” may comprise the client-side of a client-server relationship. As seen in FIG. 2, mobile application 114 comprises a geolocation SDK 206. In particular, geolocation SDK 206 may communicate with a server (such as second server 104) configured to process and generate geolocation information, including geolocation tokens. Taken together, geolocation SDK 206 and geolocation API 105 may comprise components of a location platform 201.

As discussed, embodiments include provisions for storing or caching geolocation tokens so that they may be retrieved from local memory (that is, at the device's local memory) in response to location requests from the application (and/or application server). Therefore, geolocation SDK 206 may comprise a cache 207. Cache 207 may comprise any suitable form of local storage and may be associated with any type of memory or other storage available on mobile device 100.

Mobile application 114 may include one or more location requesting processes 205. Location requesting processes 205 may comprise any processes (associated with any suitable software modules) that may request geolocation information (such as a geolocation token) from geolocation SDK 206. That is, location requesting processes 205 may comprise processes that interface, and make calls to, geolocation SDK 206, which may run as a sub-program within mobile application 114.

Geolocation SDK may have access to information from other applications, services, or processes running on mobile device 100. For example, geolocation SDK 206 may have access to networking systems 130 (see FIG. 1) to communicate with servers and retrieve networking information, to GPS receiver 140 to retrieve latitude and longitude information, and to data from one or more of sensors 150. As an example, geolocation SDK 206 may be able to access accelerometer data from sensors 150 in order to determine an approximate velocity of mobile device 100. In addition, geolocation SDK 206 may have access to information provided by the mobile device's operating system. This information may include, but is not limited to, date and time information, orientation information, mobile device ID information, user information, and other types of information. In some cases, geolocation SDK 206 may access system information through OS interface 208, which provides geolocation SDK 206 with access to systemwide information.

As seen in FIG. 2, in some embodiments, geolocation API 105 communicates with geolocation SDK 206. In some embodiments, geolocation API 105 includes a geolocation processing module 222, a spoof checking module 224, and a token generator 226. Geolocation processing module 222 may be configured to receive input information, such as a GPS location (including a latitude/longitude pair) and generate suitable output information. For example, geolocation processing module 222 may determine a state, country, and/or other region associated with a latitude/longitude pair using a geographic information system, and may output a “state” and “country” based on the provided longitude and latitude. In some cases, geolocation processing module 222 may output additional information, such as the distance to the nearest border (for example, a state border). For example, geolocation processing module 222 may first calculate a distance between the latitude/longitude pair and a closest portion of a boundary (such as a state boundary or a country boundary) and provide this distance as an output.

Spoof checking module 224 may process incoming information and determine whether the location may have been spoofed in some way. Location spoofing may be done using proxies or virtual private networks (VPNs), using GPS spoofing applications and emulators, and application tampering. Spoof checking module 224 may utilize information provided from geolocation SDK (such as lat/lon data, device data and network data) along with other data to perform various spoofing checks. These spoof checking techniques may include using multiple sources of location data (such as GPS and Wi-Fi and cell tower triangulation), detecting anomalous patterns in location data, comparing received locations to known landmarks, using a GPS simulator, or other suitable algorithms and techniques. As an example, spoof checking module 224 may receive information indicating that the mobile device is communicating through a proxy or virtual private network (VPN), and in response, determine that the latitude and longitude provided cannot be verified as the true location of the mobile device.

Token generator 226 may be configured to generate a token that may be passed back to the geolocation SDK (client). In some embodiments, the token may be a JSON (JavaScript Object Notation) Web Token.

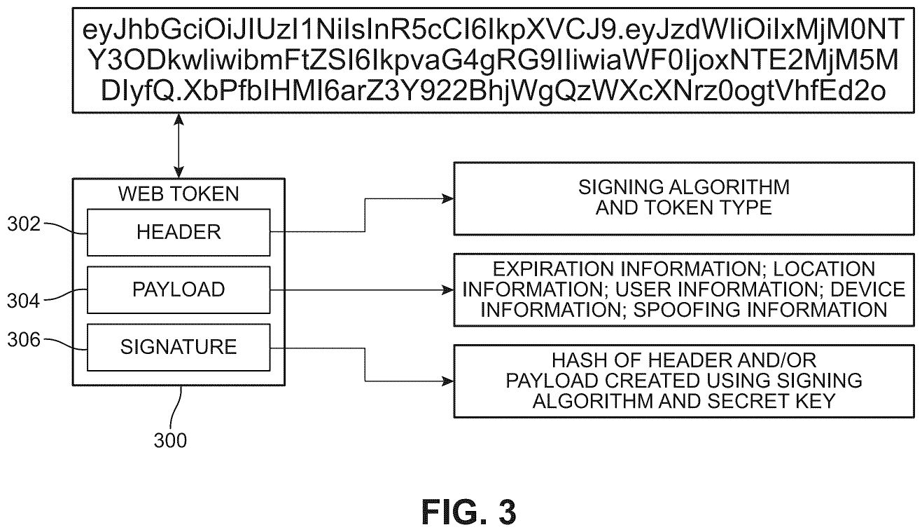

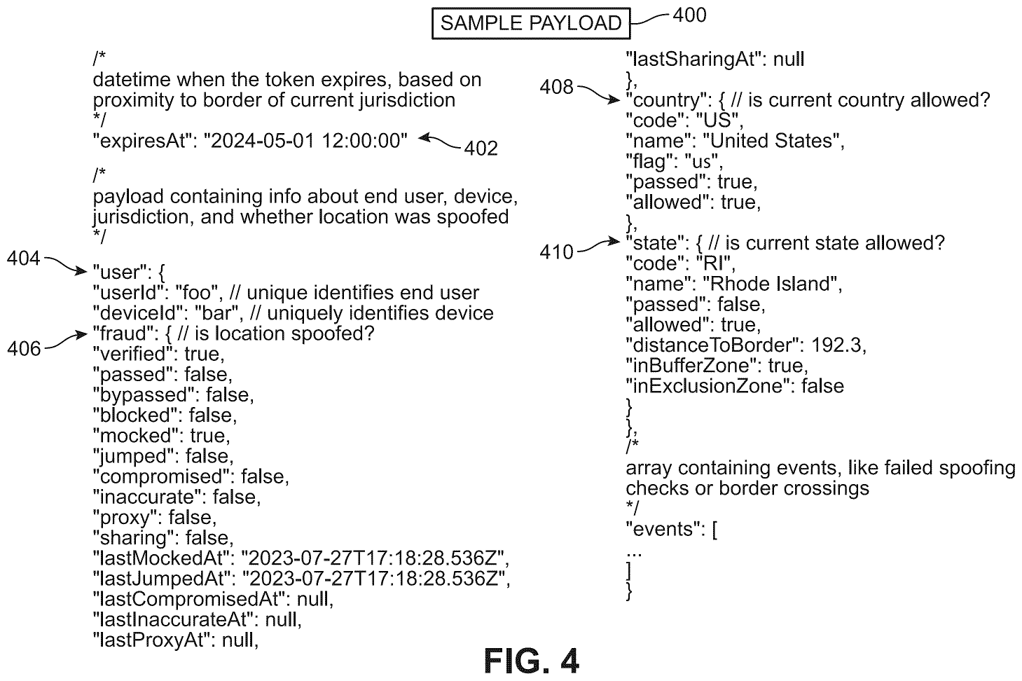

The embodiments may utilize any suitable tokens. In some embodiments, geolocation tokens may be implemented as JSON Web Tokens. To better illustrate the following description, a schematic diagram of a typical JSON web token 300 is shown in FIG. 3. Additionally, an exemplary payload 304 for a geolocation token that may be used with the exemplary systems and methods is shown in FIG. 4.

JWT is an open standard that may be used to share information between two parties in a secure manner. Broadly, a JWT includes an encoded JSON data structure comprising a set of claims and a signature that can be used to verify that the set of claims have not been altered by a party besides the sender. In some cases, JWTs may also be encrypted.

JSON web token 300 may be comprised of a header 302, a payload 304 and a signature 306. Header 302 may comprise two parts: the type of the token, which is JWT, and the signing algorithm being used, such as HMAC SHA256 or RSA. Header 302 may be encoded in Base64Url format. Header 302 provides information for an application as to how to handle the token. Payload 304 comprises claims, which are statements about an entity (typically, the user) and additional data. Payload 304 may also Base64Url encoded. In the exemplary embodiment, payload 304 comprises user information, device ID information, and device location information, as discussed below.

Signature 306 comprises a hash of header 302 and/or payload 304 that is generated using a key. To create signature 306, token generator 226 takes the encoded header, the encoded payload, a key, and the algorithm specified in the header (such as HMAC SHA256) and signs it. Signature 306 may be created in a way to ensure that the message cannot be altered without detection. That is, signature 306 may be used to verify that the sender of token 300 is who it says it is and to ensure that the message (including the information in payload 304) was not changed along the way.

In some embodiments, a secret key is shared between the party generating the token and the party receiving the token. The receiving party can then use the secret key and the hashing algorithm to check the validity of the signature.

In other embodiments that utilize a public-key based signature system, the receiving party may not need a secret key and may validate the signature using a public key.

The embodiments utilize a token with a payload including information that is relevant for purposes of geolocation and geofencing. Generally, this information may include expiration information for the geofencing token, location information (such as a state, country or other regional information), user information (such as a user ID or other identifying information), device information (including a MAC address, an IP address, a hardware ID or other device identifying information), and spoofing information. Spoofing information may include various kinds of information about attempts to spoof the user's location or various related information related to attempted fraud.

As one specific example, FIG. 4 shows sample payload information 400 provided in a decoded JSON format. Sample payload information 400 includes an expiration date/time 402 (“expiresAt”: 2024 May 1 12:00:00”) as well as user information 404 (“user”), which further includes, a user ID (“userId”) and a device ID (“deviceId”), and information about fraud/spoofing 406 (“fraud”). Sample payload information 400 also includes location information that is used by the mobile application for geofencing. Location information more specifically may include country information 408 and state information 410.

Location information includes information that may be used by a gaming application to perform geofencing or other related functionality. For example, a gaming application may need to confirm that a user is in a given state in order to abide by state locals for online gaming/gambling. Upon receiving a token with sample payload information 400, the mobile application may decode the payload and extract the relevant location information, such as the “state”, which in this example is “Rhode Island.” Additionally, because some regulations require more frequent location checks for users on gaming applications, state information 410 provides a distance to the state border (“distanceToBorder”), which in this example has a value of 192.3 miles.

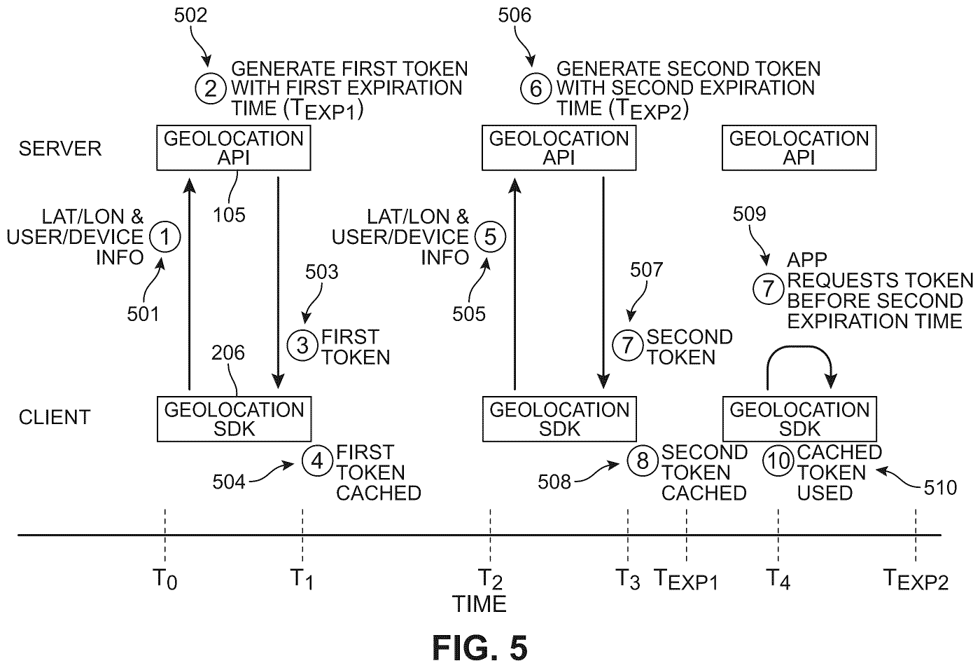

FIG. 5 is a schematic view of a process of updating geolocation tokens according to an embodiment. As seen in FIG. 5, geolocation SDK 206 runs on a client (such as mobile device 100) and geolocation API 105 runs on a server (such as second server 104). Referring to FIG. 5, a sequence of events is shown to occur over time.

Starting at an initial time, TO, in a first event 501, geolocation SDK 206 sends a request for a new geolocation token to geolocation API 105. The request may include, at least, latitude and longitude data for the mobile device as well as user and/or device information. In a second event 502, geolocation API 105 receives the request and generates a first geolocation token (“first token”) with a first expiration time (T_EXP1). In a third event 503, geolocation API 105 sends the first token to geolocation SDK 206 at a time T1. In a fourth event 504, geolocation SDK 206 caches the first token, which occurs immediately after time T1.

Later, at time T2, in a fifth event 505, geolocation SDK 206 automatically requests a new (fresh) geolocation token from the server. As part of this request, latitude/longitude and user/device information may be resent. In a sixth event 506, geolocation API 105 receives this request and accompanying information and generates a second geolocation token (“second token”) having a second expiration time (T_EXP2), which is greater (that is, occurs later in time than) the first expiration time T_EXP1. The second token is then sent to geolocation SDK 206 in a seventh event 507, which occurs at a time T3. Upon receiving the second geolocation token, SDK 206 immediately caches the token in an eighth event 508.

It may be appreciated that geolocation SDK 206 specifically requests a new (second) token in event 505 before the currently cached token (the first geolocation token received at time T1) expires. That is, the requesting time T2 occurs before T_EXP1, and furthermore, the request is made with sufficient time so that the second token can be received and cached (at time T3) before the first token expires at the first expiration time (T_EXP1).

At a time T4, during a ninth event 509, the application requests a valid geolocation token. Here, time T4 occurs before the second expiration time T_EXP2. Because the second token is stored in local memory on the mobile device where geolocation SDK 206 runs, geolocation SDK 206 can immediately retrieve and return the second token, which is still fresh/valid, without near zero latency. This allows the cached token to be used by the application in a tenth event 510, which occurs immediately after the request for the location was made.

For purposes of simplicity, FIG. 5 does not show a third geolocation token being requested, received, and cached. However, in some embodiments, a third geolocation token may be requested, received, and cached prior to the second expiration time (T_EXP2). Moreover, the third geolocation token may have a third expiration time that is greater than (occurs after) the second expiration time.

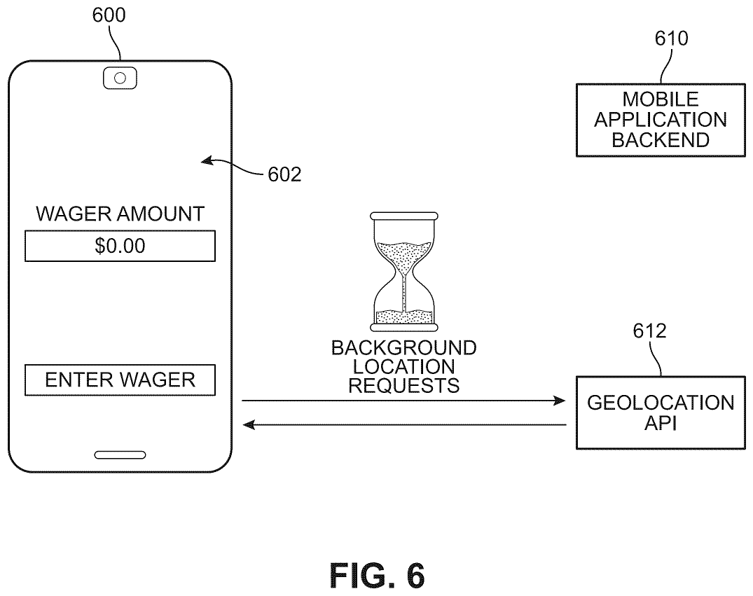

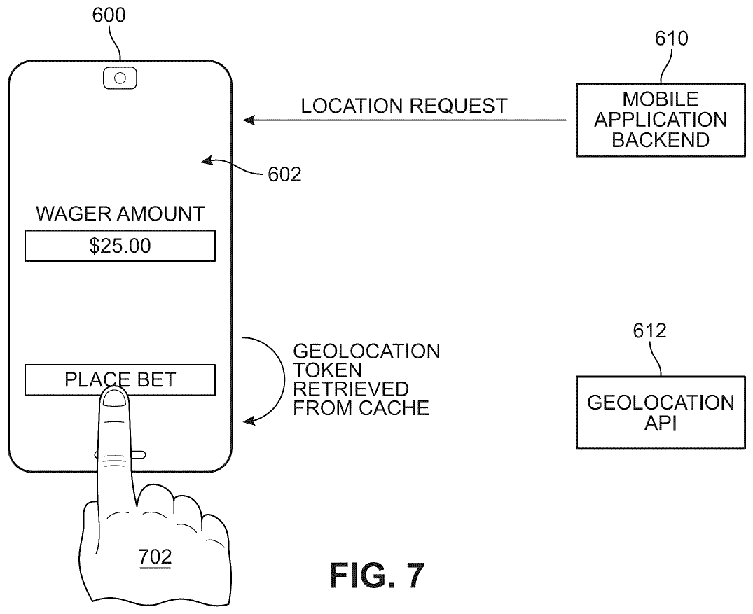

FIGS. 6 and 7 depict schematic views of a scenario where the exemplary systems may provide near zero latency for returning a geolocation token upon a request from an application. In FIG. 6, a mobile gaming application 602 is shown running on a mobile device 600. Mobile device 600 may communicate with a mobile application backend 610 running on a first server as well as a geolocation API 612 running on a second server. In the scenario of FIG. 6, a geolocation SDK operating on mobile device 600 makes requests for fresh geolocation tokens in the background. That is, requests are made during times when a user would not necessarily notice any latency. For example, in FIG. 6, a user may be considering how much to wager on a sports game or other event. At this time no location information may be required so that geolocation tokens can be requested in the background with no noticeable effect to the user experience.

FIG. 7 depicts a scenario where a user 702 attempts to place a bet using an interface of mobile gaming application 602 running on device 600. In some situations, this event initiates a request for the user's location. For example, mobile application backend 610 may push a location request, or local processes on the mobile device may make this request to confirm the user is in a particular state/locality before allowing a bet to be finalized. In this example, as soon as the location request is made, the system immediately retrieves a geolocation token from cache and provides the token (or relevant information from the token) to the requesting process. This results in a near, or even substantially zero, latency experience by the user as the bet may then be immediately confirmed.

The exemplary architecture may be compared to systems that send requests for location information at the time that an application makes a request. Such calls to the server may be relatively time intensive, and may therefore result in higher latency responses. For example, if an application makes a location request at the time that a user places a bet with the application's UI, the user may have to wait several seconds to receive confirmation that the bet has been confirmed. This leads to a degraded user experience and may ultimately result in lost revenue for the operator of the gaming application.

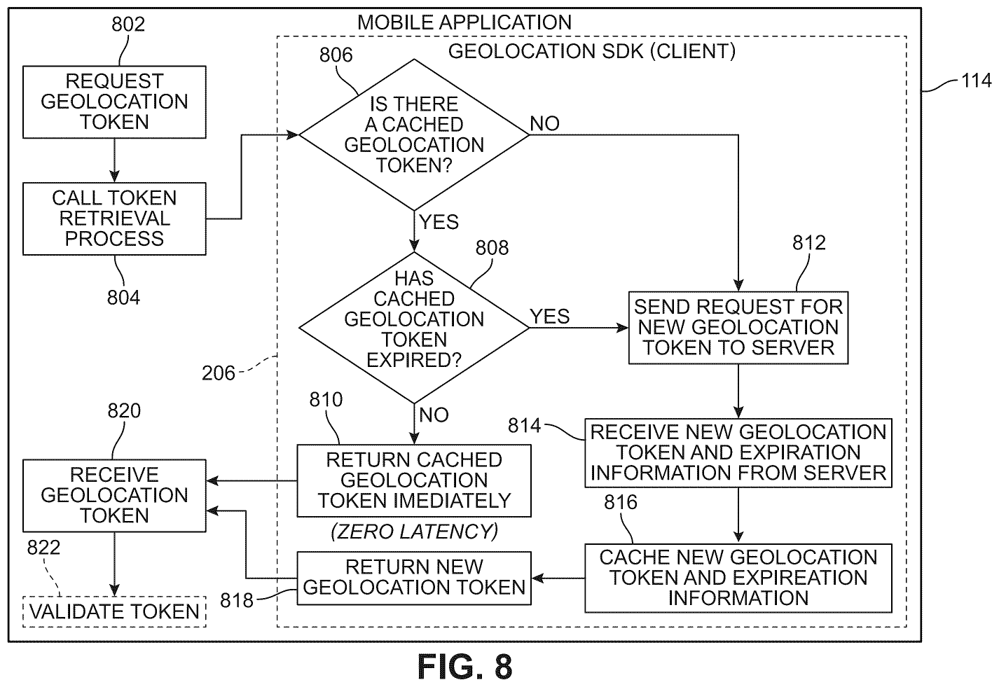

FIG. 8 is a schematic view of a process for retrieving a geolocation token in response to a request from a mobile application. As seen in FIG. 8, some operations may be performed by a mobile application (for example, mobile application 114 of FIG. 1). Some operations of the process may be performed by one or more sub-processes that comprise the client side of the location platform. For example, some operations may be performed by geolocation SDK 206 of FIG. 2). It may be understood that in other embodiments, rather than operating the client as a subprocess within the mobile application (for example, by deploying the client as part of an SDK), the client may operate as a separate module or application running alongside the mobile application on the mobile device.

In a first operation 802, mobile application 114 may request a geolocation token. For example, a gambling application may need to perform a location check for a user before the user is allowed to place a bet or when the user first logs in to a new session. The gambling application may request a geolocation token that provides the necessary location information (including, for example, the state where the user/mobile device are located as well as the distance to the closest state border). Mobile application 114 may call a token retrieval process (or subprocess) that is implemented using geolocation SDK 206, for example, in operation 804.

The token retrieval process implemented by geolocation SDK 206 begins by checking for an existing cached geolocation token in operation 806. If a token is found in operation 806, geolocation SDK 206 then checks to see if the cached token has expired in operation 808.

If a valid geolocation token is found in local memory (that is, a token that has not expired), geolocation SDK 206 proceeds to immediately returning the cached token to the requesting process of the mobile application in operation 810. This may occur with near-zero or even zero latency, since the token resides in local memory on the same device where mobile application 114 runs.

If no token is found or if the token has expired in operation 806, geolocation SDK 206 sends a request to the server for a new geolocation token in operation 812. Geolocation SDK 206 then waits until the server returns the requested geolocation token (and associated expiration information) in operation 814. The new token and expiration information are cached for later retrieval in operation 816. The new geolocation token is also provided to the requesting process of the mobile application in operation 818.

Mobile application 114, upon receiving the geolocation token in operation 820, may optionally validate the token in operation 822. Validation, in some cases, may be performed by sending the token to a validating server that has access to the secret key used to generate the signature of the geolocation token.

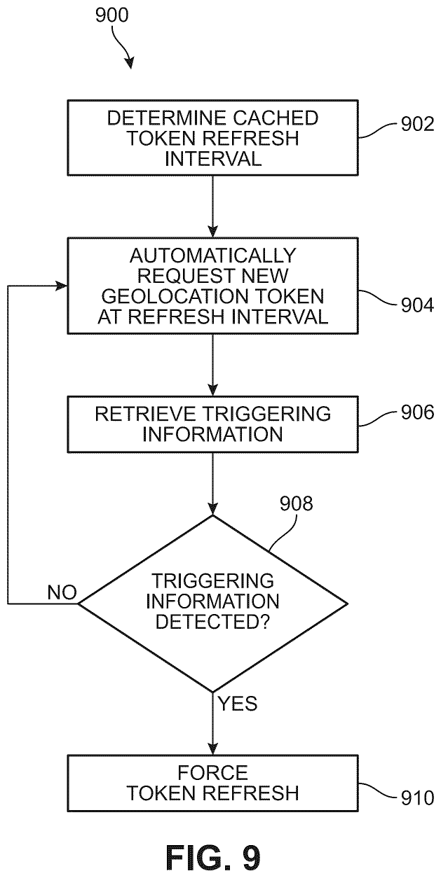

FIG. 9 is an exemplary process 900 showing how embodiments of the exemplary system may refresh geolocation tokens according to a determined refresh interval (alternatively, a refresh rate or refresh frequency) and/or dynamically in response to triggers. In some embodiments, one or more of the following operations may be performed by a geolocation SDK (such as geolocation SDK 206).

In operation 902, geolocation SDK 206 determines a cached token refresh interval. That is, geolocation SDK 206 determines how often tokens should be refreshed. The refresh time may be determined according to various factors, including, for example, location-specific regulations. As an example, gambling applications may be required to perform location checks at a predetermined frequency in accordance with the laws of a given state. Because different states may require that the location checks be performed at different frequencies/intervals, the refresh interval may be determined as a function of the current location. As an example, the system could employ tables with refresh intervals for different states (or other regions/localities) according to the frequency at which the state requires gaming applications to check a user's location. This may be referred to as the “regulated location check interval”. When a user is determined to be in a particular state, the refresh interval may be changed according to a value stored for that particular state. Moreover, as the user moves from one state to another, the refresh interval may be automatically adjusted and set to a value associated with the new state. It may be appreciated that the system will generally choose a refresh interval that is sufficiently shorter than the interval of location checks required by the relevant regulations, since the systems seeks to always have a valid token in memory and will look to cache valid tokens ahead of anticipated requests from the mobile application. In some cases, a mobile application may make location checks more frequently than is required by regulations. In such cases, where the frequency of checks by the mobile application is known, the geolocation SDK may request fresh geolocation tokens at a greater frequency than frequency of checks performed by the mobile application.

In operation 904, geolocation SDK 206 automatically requests new geolocation tokens at the refresh interval determined in the operation 902.

Generally, geolocation SDK 206 tries to anticipate how frequently the mobile application may check for a token based on information such as local regulations or default modes of the mobile application. However, situations may occur where a valid geolocation token that has yet to expire no longer contains valid information, such as valid location information. For example, a user could unexpectedly travel farther and cross a border before the token is set to expire. In this situation, geolocation SDK 206 may act to automatically refresh the geolocation token ahead of the next scheduled refresh to ensure all information in the token is valid if the mobile application makes an unexpected request.

To accommodate these dynamic changes, in operation 906, geolocation SDK 206 may receive triggering information. As used herein, triggering information includes any information that may trigger the system to dynamically change the refresh interval and/or perform a one-time token request outside of the schedule determined by the refresh interval to accommodate changes in location, new fraud-based information, or other types of information that may invalidate some of the information stored in the currently cached token.

As one example, geolocation SDK 206 may detect that a user has crossed a border unexpectedly. As another example, geolocation SDK 206 may detect that the user is moving at a high speed away from their previous location. For example, geolocation SDK 206 may determine a speed of the mobile device from (changes in) GPS information, or using accelerometer information, and determine the current speed is greater than a (stored) threshold speed. As another example, geolocation SDK 206 may detect the presence of a proxy connection associated with the mobile device that may invalidate the validity of the current token. In another example, geolocation SDK 206 may detect that the mobile device has connected to a different network. In another example, geolocation SDK 206 may detect a change in an IP address associated with the mobile device.

If triggering information is detected in operation 908, geolocation SDK 206 may force an automatic refresh of the token in operation 910. Otherwise, geolocation SDK 206 may return to the second step of automatically requesting new tokens at the determined refresh interval.

In some embodiments, rather than using a constant refresh interval, a system may determine the refresh interval dynamically according to when the current geolocation token is set to expire. For example, the system may read the expiration date and time of a geolocation token received from the server and automatically determine that the next refresh will occur at a predetermined interval (delta T) before the current token expires. Delta T could have any suitable value. In some cases, Delta T could be determined as a percentage of the different between the current time and the expiration time. As one example, Delta T could be five minutes, so that the next refresh is set to occur five minutes before the current token expires.

It is contemplated that in other embodiments, geolocation processes and functionality may be implemented at various nodes of a telecommunications network. In particular, instructions may be stored and executed at various nodes that may implement substantially similar functionality to the geolocation SDK implemented on a mobile phone in the embodiments described above.

Embodiments may include provisions for deploying some or all functionality described in earlier embodiments using one or more nodes of an intelligent telecommunications network. An intelligent network may comprise various nodes. The nodes of the intelligent network may communicate via a signaling protocol, such as the Signaling System 7 (SS7) protocols. Nodes of an intelligent network may include Service Control Points (SCPs), Service Switching Points (SSPs), Signal Transfer Points (STPs), Service Data Points (SDPs), and Intelligent Peripherals (IPs). A service control point contains the service logic and controls the execution of various telecommunication services. The service switching points are the traditional switches in the network that interact with the SCP to offer services. They detect service requests and query the service control point for instructions on how to handle them. The service transfer points are specialized routers that handle the transfer of signaling messages between different network elements. Service transfer points route signaling messages, ensuring they reach the correct destination efficiently and securely. The service data points are databases storing subscriber information and other information required by the service logic. Although not shown, some embodiments of an intelligent network may also include an intelligent peripheral. Intelligent peripherals are specialized resources that include resources for enabling advanced services on the network.

By integrating some or all of the functionality of the embodiments into nodes on an intelligent network, the system may utilize locating features of the network, and also leverage the stability of a telecommunications network.

FIG. 10 is a schematic view of an for a system that leverages an intelligent telecommunications network 1000 (or simply “intelligent network”) for facilitating detecting that a user has been deployed and performing automated actions in response.

Network 1000 may comprise various types of nodes including service switching points (SSPs) 1002, signal transfer points (STPs) 1004, and a service control point 1006. Network 1000 may also include a service data point 1007. A mobile device 1050 having some or all of the functionality of mobile device 100 of the earlier embodiments may communicate with nodes of network 1000.

In at least some embodiments, some of the functionality implemented by a location platform, including functionality implemented at the client side or the server side in the above embodiments (that is, by a geolocation SDK or a geolocation API) may be implemented across one or more nodes of network 1000. As one example, geolocation tokens could be retrieved and stored in a service data point 1007 associated with service control point 1006. Moreover, functionality for automatically retrieving new tokens and/or for detecting triggers that require new tokens to be retrieved could be implemented at one or more nodes of network 1000, such as at service control point 1006.

In some embodiments, location information for a mobile device may either be determined by one or more nodes of an intelligent network, or else the nodes may provide information useful in determining and confirming the location. For example, in one embodiment, a geolocation API may receive not only location information from a mobile device, but also from one or more nodes of an intelligent network to which the mobile device is connected. For example, whenever the mobile device is connected to a telecommunications network in a given geographic region, the geographic region may be passed to the geolocation API, for example, using processes running on a service control point and/or intelligent peripheral.

It is contemplated that in other embodiments, any of the exemplary systems and methods may be implemented on other suitable computing devices, such as desktop computers, servers, or other suitable devices. Moreover, an application incorporating the exemplary systems and methods may run as software applications for a designated operating system (including mobile operating systems) and/or as web applications that may run in the browser of a computing system.

As noted earlier, in different embodiments, the proposed mobile telephone system includes a mobile telephone device (e.g., user device) such as a mobile computing device (“mobile device”), which includes or has access to (over a network) to a mobile application (“mobile app”) that receives instructions from the remote (server) location infrastructure application. Thus, mobile app can reside entirely on the user device, be accessed over a network via a remote server, or include some components on user device and others at the remote server. In different embodiments, such a network could include one or more Wide Area Networks (WANs), Wi-Fi networks, Bluetooth or other Personal Area Networks, cellular networks, as well as other kinds of networks. In addition, the mobile telephone device can include provisions for communicating with, and processing information from, a server as well as other devices. It may be appreciated that different devices could communicate using different networks and/or communication protocols. For purposes of this disclosure, a communication protocol refers broadly to any type of communication system that enables wireless communications to/from a mobile device. A communication module of the mobile telephone device may include a wireless connection that implements or includes components providing one or more communication protocols such as Bluetooth® radio technology, communication protocols described in IEEE 802.11 (including any IEEE 802.11 revisions) such as Wi-Fi, as well as communication protocols that rely on cellular technology (such as GSM, CDMA, UMTS, EV-DO, WiMAX, or LTE), or Zigbee® technology, among other possibilities. In many cases, the communication module is a wireless connection; however, wired connections may also be used. For example, the communication module may include a wired serial bus such as a universal serial bus or a parallel bus, among other connections. Each device may include a communication system such as a radio or other provisions for communicating using one or more communication methods. In particular, the communication system includes provisions for communicating with other nearby devices and/or a server over a network. For example, each communication system could include a Wi-Fi radio, a Bluetooth radio, and/or a cellular network radio.

Furthermore, the mobile telephone device may include one or more processors and memory. As used herein, a “processor”, also commonly referred to as a central processing unit (CPU), is an integrated electronic circuit that interprets and executes instructions from the memory of the device. It can comprise one or more processing units, either as individual cores or chips. The processor can be implemented as a single microprocessor or a plurality of microprocessors for enhancing processing capabilities. The processor can be a part of a larger system, such as a microcontroller, a digital signal processor (DSP), an application-specific integrated circuit (ASIC), or a field-programmable gate array (FPGA).

As used herein, “memory” is a device's internal storage structure where the processor stores and retrieves data and instructions. Memory described herein can include volatile memory (e.g., random access memory or RAM) and non-volatile memory (e.g., erasable programmable read-only memory, flash memory, hard drives, etc.). The memory can be implemented as a single module or a plurality of modules. Furthermore, the memory modules can be situated within the processor or external to the processor, in which case they can be communicatively connected to the processor via various means, such as a bus system or direct electrical connection. Memory may comprise a non-transitory computer readable medium. Instructions stored within memory may be executed by the one or more processors. In some embodiments, an end-user can interact with the proposed system, for example via the mobile app installed on their mobile telephone device. In some embodiments, some or all components and features of the mobile app can be downloaded to be accessible locally on the device. In other embodiments, some or all components and features can be accessed via a web-based service over a network.

Instructions stored on the non-transitory computer readable medium for carrying out operations of the present invention may be instruction-set-architecture (ISA) instructions, assembler instructions, machine instructions, machine dependent instructions, microcode, firmware instructions, configuration data for integrated circuitry, state-setting data, or source code or object code written in any of one or more programming languages, including an object oriented programming language such as Smalltalk, C++, or suitable language, and procedural programming languages, such as the “C” programming language or similar programming languages.

The storage device(s) may be configured to provide (e.g., persistent) mass storage for the system. In some implementations, the storage device(s) may include one or more computer-readable media. For example, the storage device(s) may include a floppy disk device, a hard disk device, an optical disk device, or a tape device. The storage device(s) may include read-only memory, random access memory, or both. The storage device(s) may include one or more of an internal hard drive, an external hard drive, or a removable drive.

One or both of the memory or the storage device(s) may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system. In some implementations, the CRSM may include a data store that provides storage of computer-readable instructions or other information in a non-transitory format. The CRSM may be incorporated into the system or may be external with respect to the system. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) and the memory may be supplemented by, or incorporated into, one or more application-specific integrated circuits (ASICs).

A mobile device may communicate with a server computer system (or “server”). The server computer system may comprise any type of computer system, including any combination of hardware and/or software that is configured to provide access to sensor data from devices located within particular physical spaces. A server computer system may include various engines, functional blocks, and components that may be implemented on a single computer system, or may be implemented as a distributed computer system that includes elements resident in a cloud environment, and/or that implement aspects of cloud. In addition, the various engines, functional blocks, and/or components of the server computer system may be implemented as software, hardware, or a combination of software and hardware. Although not illustrated, the various engines of the server computer system may access and/or utilize a processor and memory, such as processors and the memory, as needed, to perform their various functions.

In some embodiments networking systems comprise one or more of a cellular network module, a WiFi module, a Bluetooth module, and a Near Field Communication (NFC) module. A cellular network module may comprise hardware and/or software facilitating connecting a device to a cellular network, allowing for voice calls, SMS, and mobile data transmission over various generations of cellular technologies (such as 2G, 3G, 4G, 5G, and LTE). A cellular network module may comprise a modem that modulates and demodulates radio signals to and from the cellular network. A cellular network component may work in coordination with a Subscriber Identity Module (SIM) card, which provides the user's identity to the cellular network. A WiFi network module may comprise hardware and software that facilitates high-speed internet connectivity to local wireless networks, including components that support various IEEE 802.11 standards (for example, 802.11a/b/g/n/ac/ax). In some cases, a WiFi module may support dual-band (2.4 GHz and 5 GHZ) or tri-band connectivity, offering optimized bandwidth and reduced interference. Wi-Fi modules also facilitate features such as Wi-Fi Direct for peer-to-peer connections without a network. A Bluetooth module includes hardware and/or software facilitating short-range wireless communication with other Bluetooth-enabled devices, such as headphones, speakers, car systems, and wearable devices. Alternatively, a networking system can include provisions to facilitate communication over a different personal area network (PAN) other than a Bluetooth network. An NCF module may include hardware and/or software to facilitate communication with components that are within a threshold proximity on the order of a few centimeters.

The embodiments may utilize any kind of network for communication between separate computing systems. A network can comprise any combination of local area networks (LANs) and/or wide area networks (WANs), using both wired and wireless communication systems. A network may use various known communications technologies and/or protocols. Communication technologies can include, but are not limited to: Ethernet, 802.11, worldwide interoperability for microwave access (WiMAX), mobile broadband (such as CDMA, and LTE), digital subscriber line (DSL), cable internet access, satellite broadband, wireless ISP, fiber optic internet, as well as other wired and wireless technologies. Networking protocols used on a network may include transmission control protocol/Internet protocol (TCP/IP), multiprotocol label switching (MPLS), User Datagram Protocol (UDP), hypertext transport protocol (HTTP), hypertext transport protocol secure (HTTPS) and file transfer protocol (FTP) as well as other protocols.

Data exchanged over a network may be represented using technologies and/or formats including hypertext markup language (HTML), extensible markup language (XML), Atom, JavaScript Object Notation (JSON), YAML, as well as other data exchange formats. In addition, information transferred over a network can be encrypted using conventional encryption technologies such as secure sockets layer (SSL), transport layer security (TLS), and Internet Protocol security (Ipsec).

The system may include one or more I/O devices. The I/O device(s) may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) may also include one or more output devices such as a display, LED(s), an audio output device (e.g., a speaker), a printer, a haptic output device, and so forth. The I/O device(s) may be physically incorporated in one or more computing devices of the system, or may be external with respect to one or more computing devices of the system.

The system may include one or more I/O interfaces to enable components or modules of the system to control, interface with, or otherwise communicate with the I/O device(s). The I/O interface(s) may enable information to be transferred in or out of the system, or between components of the system, through serial communication, parallel communication, or other types of communication. For example, the I/O interface(s) may comply with a version of the RS-232 standard for serial ports, or with a version of the IEEE 1284 standard for parallel ports. As another example, the I/O interface(s) may be configured to provide a connection over Universal Serial Bus (USB) or Ethernet. In some examples, the I/O interface(s) may be configured to provide a serial connection that is compliant with a version of the IEEE 1394 standard. The I/O interface(s) may also include one or more network interfaces that enable communications between computing devices in the system, or between the system and other network-connected computing systems. The network interface(s) may include one or more network interface controllers (NICs) or other types of transceiver devices configured to send and receive communications over one or more networks, such as the network(s), using any network protocol.

The system may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

It is appreciated that methods in accordance with the present disclosure can include any combination of the aspects and features described herein. That is, methods and systems in accordance with the present disclosure are not limited to the combinations of aspects and features specifically described herein, but also include any combination of the aspects and features provided.

Aspects of the present disclosure are described in association with figures illustrating flowcharts and/or block diagrams of methods, apparatus (systems), and computing products. It will be understood that each block of the flowcharts and/or block diagrams can be implemented by computer readable instructions. The flowcharts and block diagrams in the figures illustrate the architecture, functionality, and operation of possible implementations of various disclosed embodiments. Accordingly, each block in the flowchart or block diagrams may represent a module, segment, or portion of instructions. In some implementations, the functions set forth in the figures and claims may occur in an alternative order than listed and/or illustrated.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

While various embodiments of the invention have been described, the description is intended to be exemplary, rather than limiting, and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

We claim:

1. A mobile device operating on a telecommunications network, comprising:
a processor;
a non-transitory computer-readable media storing instructions that are executable by the processor to:
request a geolocation token from a server;
receive the geolocation token from the server;
receive expiration information for the geolocation token;
store the geolocation token in memory at the mobile device;
store the expiration information in memory at the mobile device;
receive, from a mobile application process running on the mobile device, a token request;
retrieve the geolocation token and the expiration information from memory;
determine that the geolocation token is still valid according to the expiration information; and
provide the geolocation token to the mobile application process.

2. The mobile device according to claim 1, wherein the instructions are further executable to:
determine latitude and longitude information for the mobile device; and
send the latitude and longitude information to the server as part of the request for the geolocation token.

3. The mobile device according to claim 1, wherein the expiration information is stored in the geolocation token.

4. The mobile device according to claim 1, wherein the expiration information includes a first expiration time and wherein the instructions are further executable by the processor to:
request a second geolocation token from the server before the geolocation token expires according to the first expiration time;
receive the second geolocation token from the server with a second expiration time for the second geolocation token, wherein the second expiration time is later than the first expiration time; and
store the second geolocation token and the second expiration time in memory.

5. The mobile device according to claim 1, wherein the instructions are further executable by the processor to:
automatically request additional geolocation tokens from the server at a predetermined refresh interval.

6. The mobile device according to claim 1, wherein the instructions are further executable by the processor to:
automatically request a new geolocation token from the server in response to detecting triggering information.

7. A computer-implemented method running on a computing device, comprising:
requesting a geolocation token from a server;
receiving the geolocation token from the server;
receiving expiration information for the geolocation token;
storing the geolocation token in memory at the computing device;
storing the expiration information in memory at the computing device;
receiving, from an application process running on the computing device, a token request;
retrieving the geolocation token and the expiration information from memory;
determining that the geolocation token is still valid according to the expiration information; and
providing the geolocation token to the application process.

8. The computer-implemented method according to claim 7, wherein the geolocation token includes location information.

9. The computer-implemented method according to claim 7, wherein the expiration information is stored in the geolocation token.

10. The computer-implemented method according to claim 7, wherein the expiration information includes a first expiration time and wherein the method further includes:
requesting a second geolocation token from the server before the geolocation token expires according to the first expiration time;
receiving the second geolocation token from the server with a second expiration time for the second geolocation token, wherein the second expiration time is later than the first expiration time; and
storing the second geolocation token and the second expiration time in memory.

11. The computer-implemented method according to claim 7, wherein the method further includes automatically requesting additional geolocation tokens from the server at a predetermined refresh interval.

12. The computer-implemented method according to claim 7, wherein the method further includes automatically requesting a new geolocation token from the server in response to detecting triggering information.

13. The computer-implemented method according to claim 12, wherein detecting the triggering information includes determining that a mobile device is traveling at a speed above a threshold speed.

14. A computer-implemented method, comprising:
receiving a first request for a first geolocation token from an application running on a computing device;
generating the first geolocation token;
sending the first geolocation token to the application running on the computing device, the first geolocation token expiring at a first expiration time;
receiving, before the first expiration time, a second request for a second geolocation token from the application running on the computing device; and
generating the second geolocation token;
sending the second geolocation token to the application running on the computing device, the second geolocation token expiring at a second expiration time that is later than the first expiration time.

15. The computer-implemented method according to claim 14, wherein the first request for the first geolocation token includes latitude and longitude information for the computing device.

16. The computer-implemented method according to claim 14, wherein the first request for the first geolocation token includes information about the computing device.

17. The computer-implemented method according to claim 14, wherein the first request for the first geolocation token includes information about a user of the computing device.

18. The computer-implemented method according to claim 14, wherein the first geolocation token and the second geolocation token are JSON Web Tokens.

19. The computer-implemented method according to claim 15, wherein generating the first geolocation token includes determining if the latitude and longitude information has been spoofed.

20. The computer-implemented method according to claim 14, wherein the first geolocation token includes spoofing information.
